(19) United States
(12) Patent Application Publication
(10) Pub. No.: US 2005/0173577 A1
(43) Pub. Date: Aug. 11, 2005

(54) Tape drive system

(75) Inventor: Mikio Ohno, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/023,448

(22) Filed: Dec. 29, 2004

(30) Foreign Application Priority Data
Feb. 5, 2004 (JP) 2004-029176

(51) Int. Cl. G11B 15/67; G11B 23/107

(52) U.S. Cl. 242/332.7; 242/348

(57) ABSTRACT

Disclosed is a tape drive system which can wind magnetic tapes in proper alignment and which minimizes the possibility of tape impressions on magnetic tapes even if the core of the take-up reel has step heights on its peripheral surface. The tape drive system includes a tape-shaped recording medium having a head edge where a leader tape is formed to prevent tape impressions from being formed on the tape-shaped recording medium itself; a plurality of grooves formed on a flange of the take-up reel or the supply reel, the grooves for directing an airflow to an outside of the flange upon winding of the tape-shaped recording medium; and the leader tape having a surface of a center line average roughness ranging from 10 nm to 60 nm and a total thickness ranging from 10 μm to 40 μm while being wounded around or the take-up reel.

### BACKGROUND OF THE INVENTION

1. Field of the Invention

An apparatus consistent with the present invention relates to a tape drive system used for tape-shaped recording media, such as magnetic tapes, having a leader tape portion at their head edge. More specifically, an apparatus consistent with the present invention relates to a tape drive system which uses its take-up reel to forward/rewind a recording medium and, simultaneously records/reproduces information on or from the medium.

2. Description of the Related Art

Conventionally, as external backup recording media for computers, etc., magnetic tape cartridges in compliance with LTO (linear tape open) standard have been known. Such a magnetic tape cartridge contains a magnetic tape composed of a leader tape portion and a magnetic tape portion; the leader tape portion, on which information is not recorded, is formed at the head edge of the magnetic tape, and the magnetic tape portion, on which information is to be recorded, follows the leader tape portion. Before being played, a magnetic tape cartridge of this type is loaded into a tape drive, and is then played by the tape drive.

Once a magnetic tape cartridge is loaded into such a tape drive, the drive leader of this tape drive uses its pull-out portion to hook the leader block at the head edge of leader tape portion of the magnetic tape cartridge. The tape drive includes a take-up reel for winding/rewinding magnetic tapes. This take-up reel has a core forming the peripheral surface of the take-up reel, and this core is provided with a recess. The leader block that has been hooked by the pull-out portion is pulled out from the cartridge, and is then accommodated into the recess, together with the pull-out portion. Following this, the leader tape portion is drawn from the cartridge toward the take-up reel. An example of this mechanism is described in Japanese Unexamined Patent Application No. 8-195002.

By means of the rotation of the take-up reel, the leader tape is guided to the take-up reel, and is then wrapped around the core of the take-up reel. Subsequently, the magnetic tape portion following the leader tape portion is pulled out. Simultaneously, a read-write head, etc., which are positioned on a transport route of the magnetic tape, records/reproduces information on or from the magnetic tape portion.

In this state, the leader block accommodated in the recess forms the segment of the peripheral surface of the core.

This mechanism is schematically shown in FIG. 4A. A leader block 40 is fitted into a recess 42 formed in the radius direction of a core 41, so that an edge surface 40a of the leader block 40 forms the peripheral surface of the core 41. As shown in FIG. 4A, this arc-shaped edge surface 40a is formed to be flush with the peripheral surface of the core 41 in order to smoothly wind the magnetic tape MT.

The leader block 40, however, has a dimensional tolerance, and the edge surface 40a may protrude from the peripheral surface of the core 41 due to this tolerance, as shown in FIG. 4B. If the edge surface 40a protrudes, then measurable levels of step heights are formed between the edge surface 40a and the peripheral surface of the core 41.

These step heights form creases and deformations (so-called “tape impressions”) on the leader tape LT, as well as the whole of the magnetic tape MT, as shown in FIG. 4C. These tape impressions may cause some disadvantages, such as an appropriate distance between a tape and a read-write head cannot be ensured during an information recording/reproducing stage. As a result, recording errors or lack of information may arise.

Such tape impressions may not appear, as long as the magnetic tape MT is wound around the take-up reel for a short time. However, if the magnetic tape MT stays wound for a long time, then tape impressions may appear on the magnetic tape MT at regular intervals substantially equal to the circumference of the core 41.

On the other hand, there has been a demand that magnetic tapes are wound in proper alignment. This is because, if a magnetic tape is wound irregularly, then its edges are prone to be damaged, thereby deteriorating its properties. One method for winding a magnetic tape in proper alignment is to increase the winding strength of a magnetic tape. In this case, however, if the edge surface 40a of the leader block 40 protrudes from the peripheral surface of the core 41 as shown in FIGS. 4A to 4C, then tape impressions are more likely to occur on a magnetic tape.

The present invention has been conceived, taking the above disadvantages into account. An object of the present invention is to provide a tape drive system which can wind recording media in proper alignment and which minimizes the possibility of tape impressions on recording media even if the core of the take-up reel has step heights on its peripheral surface.

### SUMMARY OF THE INVENTION

According to an aspect of the present invention, there is provided, a tape drive system including a tape-shaped recording medium, a supply reel and a take-up reel, for winding the tape-shaped recording medium wound around the supply reel to the take-up reel or for winding the tape-shaped recording medium wound around the take-up reel to the supply reel, and simultaneously for recording/reproducing information to or from the tape-shaped recording medium, the tape drive system being constituted of:
(1) a leader tape formed at a head edge of the tape-shaped recording medium, wherein the leader tape intends to prevent tape impressions from being formed on the tape-shaped recording medium;
(2) a plurality of grooves formed on an inner surface of an flange of the take-up reel or the supply reel, the grooves for directing an airflow to an outside of the flange, the airflow being generated upon winding of the tape-shaped recording medium; and
(3) the leader tape having a surface of a center line average roughness ranging from 10 nm to 60 nm, the leader tape having a total thickness ranging from 10 μm to 40 μm while being wounded up around the supply reel or the take-up reel.

In this tape drive system, the grooves function as exhaust paths, and an airflow generated by the transportation of the recording medium is directed to the outside of the take-up reel through these grooves. In addition, due to the roughness of the surface of the leader tape, an elastic force is exerted on the leader tape portion being wound around the drive reel, so that the step heights are absorbed.

According to another aspect of the present invention, in the tape drive system above, the leader tape has a length to be wound at least three, seven, twelve or twenty times around the supply reel or the take-up reel.

In this tape drive system, the leader tape is stacked on the drive reel or the take-up reel, and the recording medium is further wound around the circumference of the leader tape being stacked. Hence, even if step heights are formed on the core of the take-up reel, the stacked leader tape portion absorbs the step heights.

In conclusion, it is possible to provide a tape drive system which can wind recording media in proper alignment and which minimizes the possibility of tape impressions on recording media even if the core of the take-up reel has step heights on its peripheral surface.

### BRIEF DESCRIPTION OF THE DRAWINGS

For more complete understanding of the present invention and the advantages hereof, reference is now made to the following description taken in conjunction with the accompanying drawings wherein:

FIG. 1 is a schematic structural view depicting a tape drive system according to an embodiment of the present invention;

FIG. 2 is an exploded perspective view depicting a magnetic tape cartridge used in the tape drive system;

FIG. 3A is a perspective view depicting a drive reel (take-up reel) used in the tape drive system;

FIG. 3B is a partial exploded cross-sectional view taken along a line b-b of FIG. 3A.

FIG. 4A is a schematic view depicting a mechanism in which a core of a drive reel winds a leader tape portion;

FIG. 4B is a schematic view depicting a mechanism in which the core of the drive reel winds the leader tape portion; and

FIG. 4C is a schematic view depicting a mechanism in which the core of the drive reel winds the leader tape portion;

### DETAILED DESCRIPTION OF THE EXEMPLARY EMBODIMENTS OF THE INVENTION

A description will be given below in detail of a tape drive system according to an embodiment of the present invention, with reference to accompanying drawings. In this embodiment, a tape drive system incorporates a magnetic tape cartridge and a magnetic tape drive (tape drive). The magnetic tape cartridge contains a tape-shaped recording medium wound around a cartridge reel (supply reel) of the magnetic tape drive. The magnetic tape drive (tape drive) is a device into which the magnetic tape cartridge is loaded.

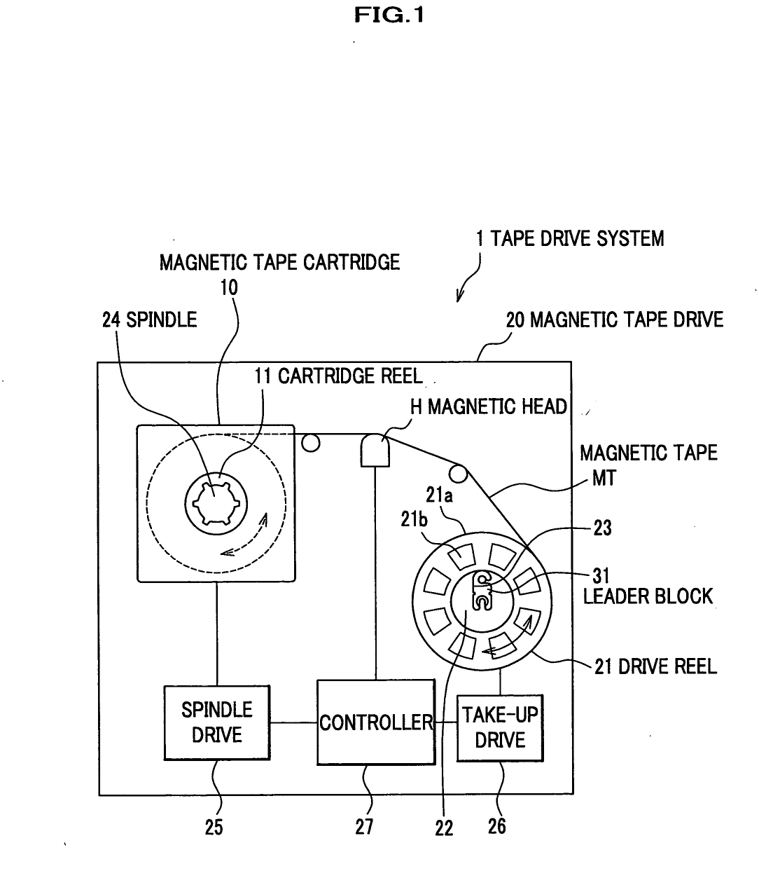

Referring to FIG. 1, a tape drive system 1 includes a magnetic tape cartridge 10 and a magnetic tape drive 20. In this tape drive system 1, the magnetic tape drive 20 winds, to a drive reel 21, a tape-shaped recording medium, that is, a magnetic tape MT contained in the magnetic tape cartridge 10, or rewinds the magnetic tape MT wound around the drive reel 21 to the cartridge reel (supply reel) 11 and, simultaneously records/reproduces information to or from the magnetic tape MT.

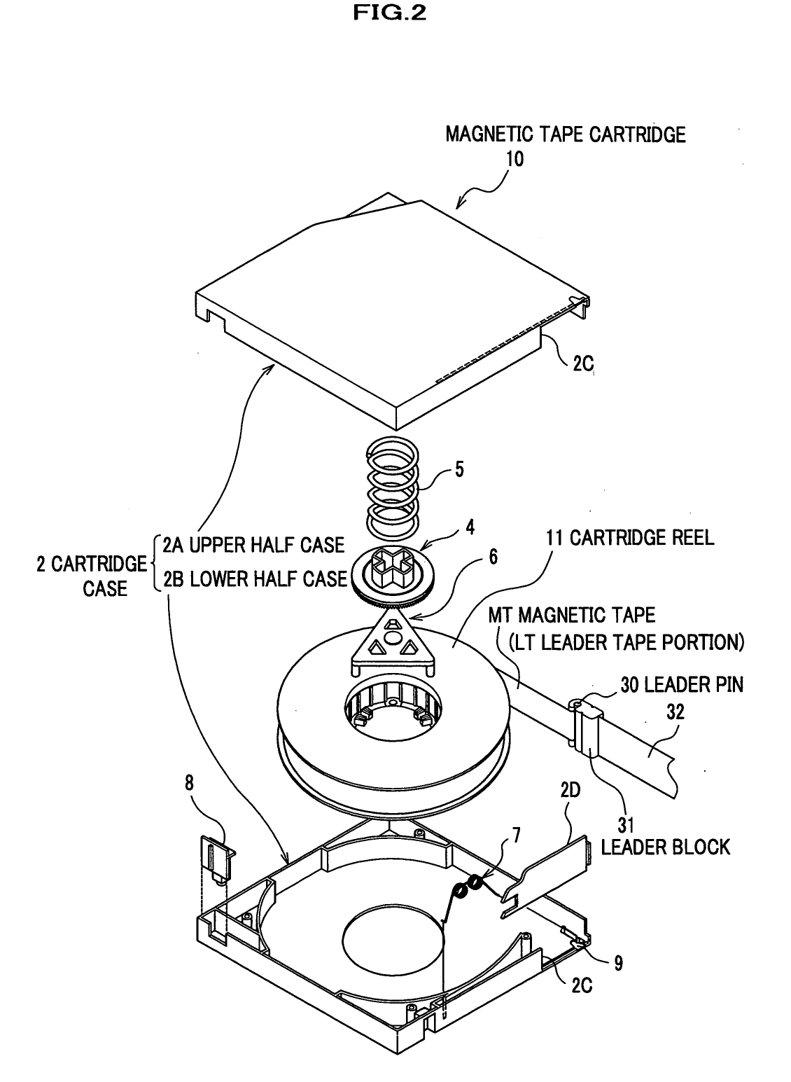

Referring to FIG. 2, the magnetic tape cartridge 10 is consistent with the LTO standard, and includes a cartridge case 2 composed of upper and lower half cases 2A and 2B. Further, the magnetic tape cartridge 10 contains, in the cartridge case 2;
(1) a cartridge reel 11 around which the magnetic tape MT is wound beforehand;
(2) a reel lock 4 and a compressed coil spring 5 which both keep the cartridge reel 11 locked;
(3) a release pad 6 which releases the lock of the cartridge reel 11;
(4) a slide door 2D which is provided on a side of the cartridge case 2 and across both the upper and lower half cases 2A and 2B, and which opens/closes a magnetic tape drawing opening 2C;
(5) a torsion coil spring 7 which urges the slide door 2D in the direction where the magnetic tape drawing opening 2C is closed;
(6) a safety lug 8; and
(7) a leader pin receiving portion 9 provided near the magnetic tape drawer opening 2C.

Furthermore, a leader tape portion LT is formed at the head edge of the magnetic tape MT. The magnetic tape MT shown in FIG. 2 corresponds to the leader tape portion LT.

As shown in FIG. 1, once the magnetic tape cartridge 10 is loaded into the magnetic tape drive 20, the leader tape portion LT is pulled out from the magnetic tape cartridge 10 through the leader block 31 described later, and this leader block 31 is then fitted into a recess 23 formed on a core 22 of the drive reel 21 in the magnetic tape drive 20. Subsequently, the leader tape portion LT of the magnetic tape cartridge 10 is wound around the core 22 of the drive reel 21.

A description will be given below in detail of the magnetic tape MT and its leader tape portion LT in the magnetic tape cartridge 10 according to the embodiment. The length of the leader tape portion LT is long enough to be wound three times around the core 22 of the drive reel 21 in the magnetic tape drive 20 in this embodiment. The leader tape portion LT is preferably 0.5 m to 5.0 m in length, and more preferably 0.9 m.

The leader tape portion LT includes a supporting body (not shown) and upper and lower layers which are both formed on the supporting body.

The supporting body is preferably made of a non-magnetic flexible supporting body, and may be a known film made of polyester including polyethylene terephthalate and polyethylene naphthalate, polyolefin, cellulose triacetate, polycarbonate, aromatic or aliphatic polyamide, polyimide, polyamide-imide, polysulfone, polyaramide, or polybenzoxazol. Especially, polyethylene terephthalate or polyimide film is preferable. The supporting body may undergo beforehand a corona discharge treatment, a plasma treatment, an adhesion enhancing treatment, a thermal treatment, a dust removal treatment and the like. The supporting body has an elastic modulus of equal to/less than 630 kg/mm² (6.2 GPa) along the length, and of equal to/less than 580 kg/mm² (5.7 GPa) along the width. Preferably it is equal to/less than 550 kg/mm² (5.4 GPa) in both the length and the width.

The lower and upper layers (double layers) formed on the supporting body contain at least a lubricant, a powder, a binding agent. The lower and upper layers may be formed on at least one surface of the supporting body, but preferably, it is formed on at least the surface to be in contact with the magnetic head H (see FIG. 1). On the opposite surface where the double layers are formed, a single layer containing a powder and a binding agent may be formed, or alternatively no layers may be formed. The components contained in the lower and upper layers may be the same as or different from one another except the lubricant, as long as they can be added appropriately to these layers. The quantity of the lubricant added to the lower layer is equal to/more than 1.12 times, preferably 1.12 to 1.34 times greater than that added to the upper layer.

Note that the lubricant means a fatty acid, a fatty acid ester and a fatty acid amide in this embodiment. As for the quantity of the lubricant added to the upper layer, the ratio of fatty acid: fatty acid ester: fatty acid amide is preferably 0.1 to 1.1:0.5 to 3.5:0 to 0.5 relative to the powder of 100 parts by weight, and more preferably 0.4 to 0.6:1.0 to 2.0:0 to 0.30. Similarly, as for the quantity of the lubricant added to the lower layer, the ratio of fatty acid: fatty acid ester: fatty acid amide is 0.05 to 3.0:0.5 to 2.0:0 to 0.5, preferably 0.05 to 0.20:0.5 to 1.0:0 to 0.3.

The powder added to the double layers may be either an inorganic or organic substance. Examples of the inorganic substance include a metal and a metal oxide, and examples of the organic substance include various resins.

The total thickness of the leader tape is preferably 10 μmm to 40 μm, and more preferably 10 μm to 20 μm. The thickness of the upper layer is preferably 0.1 μm to 2.0 μm, and more preferably 0.5 μm to 1.0 μm; the thickness of the lower layer is preferably 1.0 μm to 3.0 μm, and more preferably 1.6 μm to 2.0 μm; and the thickness of the supporting body is preferably 12 μm to 16 μm, and more preferably 13 μm to 15 μm.

It is preferable that the upper layer of the leader tape portion LT has a center line average roughness Ra of 10 nm to 60 nm. Owing to this roughness, the leader tape portion LT acquires an appropriate resiliency when being wound around the core 22 of the drive reel 21 (see FIG. 1). In addition, the cleaning effect on the magnetic head H (see FIG. 1) is also obtained.

A method for adjusting the center line average roughness Ra include the steps of: selecting the center line average roughness Ra of the surface of the supporting body on which the upper layer is to be formed; selecting the size of the powders contained in the lower and upper layers; and optimizing a linear load and the roughness of rolls in a surface-forming treatment such as a calender treatment.

It is preferable that the leader tape portion LT has a back layer on the opposite surface of the supporting body where the double layers are formed. Further, the upper and back layers have a surface electric resistance of preferably equal to/less than 10¹⁰Ω/sq, and more preferably equal to/less that 10⁹Ω/sq. Owing to this surface resistance, the leader tape portion LT is prevented from being charged electrically and being damaged by static electricity from the magnetic head H (see FIG. 1), thereby enhancing the reliability of the leader tape portion LT.

Moreover, since the leader tape portion LT which is generally stronger than the magnetic tape MT is load/unloaded into or from the magnetic tape drive 20, the durability of the magnetic tape MT is enhanced.

A method for controlling the surface electric resistance to a predetermined value includes the step of adding a conductive powder such as a carbon black to at least one of the lower, upper and back layers. For example, the carbon black of 1 to 20 parts by weight relative to the binding agent of 100 parts by weight in each layer is added to the layer.

In the leader tape portion LT above, it is preferable that the lower layer is made of a non-magnetic layer containing an inorganic powder and a binding agent; the upper layer is made of a magnetic layer containing a ferromagnetic powder and a binding agent; and the back layer is formed on the opposite surface where the above layers are formed.

Each layer of leader tape portion LT will be described in detail below

(Magnetic Layer)

<Binding Agent, etc. for Magnetic and Non-Magnetic Layers>

A binding agent is a conventionally known thermoplastic resin, a thermosetting resin, a reactive resin or a mixture thereof. The thermoplastic resin which has a glass transition temperature of −100 to 150 degrees, a number average molecular weight of 1,000 to 200,000 and preferably 10,000 to 100,000, and a polymerization degree of about 50 to 1,000 is used.

Examples of the thermoplastic resin include, but are not restricted to, a polymer or copolymer, polyurethane resin and various rubber resins. The polymer or copolymer is obtained by copolymerizing two or more following units: vinyl chloride; vinyl acetate; vinyl alcohol; maleic acid; acrylic acid; acrylates; vinylidene chloride; acrylonitrile; methacrylic acid; methacrylate esters, styrene; butadiene; ethylene; vinyl butyral; vinyl acetal; and vinyl ethers. Moreover, examples of a thermosetting or reactive resin include, but not restricted to, a phenolic resin, epoxy resin, polyurethane cured resin, urea resin, melamine resin, alkyd resin, acrylic reaction resin, formaldehyde resin, silicone resin, epoxy-polyamide resin, a mixture of polyester resin and isocyanate prepolymer, a mixture of polyester polyol and polyisocyanate, a mixture of polyurethane and polyisocyanate. Details of these resins are described in “Plastic Handbook” published by Asakura Publishing. In addition, a known electron curable resin can be used for respective layers. This application and its fabricating method are described in Japanese Unexamined Patent Application 62-256219.

The resin(s) cited above can be used alone or in combination, but it is preferable that a polyurethane resin, a polyisocyanate resin and at least one selected from a vinyl chloride resin, a vinyl chloride/vinyl acetate copolymer resin, a vinyl chloride/vinyl acetate copolymer, vinyl alcohol copolymer resin, or a vinyl chloride vinyl acetate/maleic anhydride copolymer resin are used in combination in this embodiment.

The quantities of the binding agents added to the magnetic and non-magnetic layers are typically 5% to 50% by weight relative to the ferromagnetic powder and the non-magnetic inorganic powder, and more preferably 10% to 30% by weight, respectively. It is preferable that the vinyl acetate resin of 5% to 30% by weight, the polyurethane resin of 2% to 20% by weight, and the polyisocyanate resin of 2% to 20% by weight are used in combination. However, if the head is corroded by a small quantity of antichlor, then only both the polyurethane resin and isocyanate resin may be used.

In this leader tape portion LT, it is obvious that the various conditions including the quantity of the binding agent, the quantity of the vinyl acetate resin, polyurethane resin, polyisocyanate resin and other resins in the binding agent, the molecular weight of the resins forming the magnetic layer, the quantity of the polar group, and the physical properties of the resin described above may be changed for each layer as appropriate. They would rather be optimized for each layer. This optimization is done by applying a known technique regarding multi-magnetic layers. For example, for each layer, increasing the binding agent added to the magnetic layer is effective to a decrease in scratches on the surface of the leader tape portion LT. In addition, increasing the binding agent added to the non-magnetic layer renders the leader tape portion LT more elastic, thereby enhancing the touch property of the magnetic tape on the head.

(Non-Magnetic Layer)

The inorganic powder added to the non-magnetic layer is a non-magnetic powder, and can be selected from inorganic compounds including a metal oxide, a metal carbonate salt, a metal sulfate salt, a metal nitride, a metal carbide and a metal sulfide, for example. The carbon black is mixed in the non-magnetic layer to thereby produce known effects, such as the surface electric resistance Rs is decreased and the light transmittance is lowered, and to further acquire a desired micro Vickers hardness. In addition, the carbon black also serves as a lubricant. Examples of the carbon black include a furnace black for rubbers, a thermal black for rubbers, a coloring black and an acetylene black. In addition, an organic powder may be added to the non-magnetic layer as appropriate. Moreover, in this non-magnetic layer, a known technique may be applied to lubricants, dispersers, addition agents, solvents, a dispersion method, etc.

(Addition Agent)

As addition agents used for the magnetic and non-magnetic layers, ones producing the head polishing, lubricating, antistatic, dispersing and plasticizing effects are used. These specific examples are described in International Publication WO98/35345 leaflet.

Examples of the lubricant are constituted of:
(1) monobasic fatty acid (C=10 to 24);
(2) metal salt of the monobasic fatty acid (e.g. Li, Na, K, Cu, etc.);
(3) monobasic fatty acid (C=10 to 24), and mono-, di- or tri-fatty acid ester containing one of monovalent, bivalent, tervalent, quadrivalent, pentavalent and hexavalent alcohols (C=2 to 12);
(4) fatty acid ester containing mono-alkyl ether of alkylene oxide polymer; and
(5) acid amido (C=8 to 22).

Note that the fatty acid and the alcohols may contain unsaturated bonds and may be branched.

(Back Layer)

It is preferable that the back layer contains the carbon black and the inorganic powder. The binding agent and the addition agents added to the back layer can be the same as those added to the magnetic and non-magnetic layers. The thickness of the back layer is preferably 0.1 μm to 1.0 μm, and more preferably 0.4 μm to 0.6 μm.

(Fabricating Method)

The components cited above are dissolved or dispersed in a solvent, thereby producing individual coating materials. Further, these coating materials are applied to the supporting body (web), so that the magnetic and non-magnetic layers are formed. Examples of this applying technique include a wet-on-wet technique by which the material of the magnetic layer is applied to the wet non-magnetic layer, and a wet-on-dry technique by which the material of the magnetic layer is applied to the dried non-magnetic layer. The web on which the individual layers are formed undergoes an orientation treatment, a dry treatment, a calender treatment and a slit treatment.

Next, the magnetic tape drive 20 will be described below.

Referring to FIG. 1, the magnetic tape drive 20 includes a spindle 24, a spindle drive 25 that drives the spindle 24, a magnetic head H, a drive reel 21, a take-up drive 26 that drives the drive reel 21, and a controller 27.

The magnetic tape drive 20 is provided with the leader block 31 that can hook a leader pin 30 (see FIG. 2) at the head edge of the leader tape portion LT in the magnetic tape cartridge 10. This leader block 31 is moved toward the magnetic tape cartridge 10 by means of a pull-out mechanism (not shown) including a pull-out guide 32.

When information is recorded/reproduced on or from the magnetic tape MT, the magnetic tape drive 20 allows the spindle drive 25 and the take-up drive 26 to rotatably drive the spindle 24 and the drive reel 21, respectively, so that the magnetic tape MT is transported.

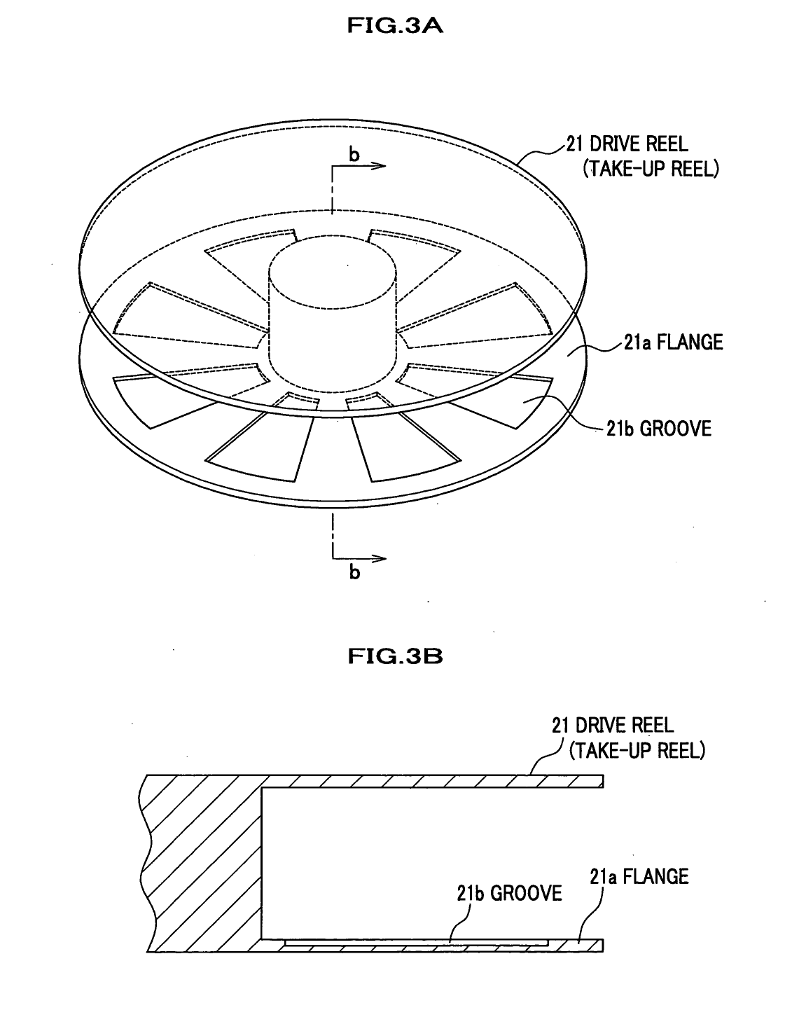

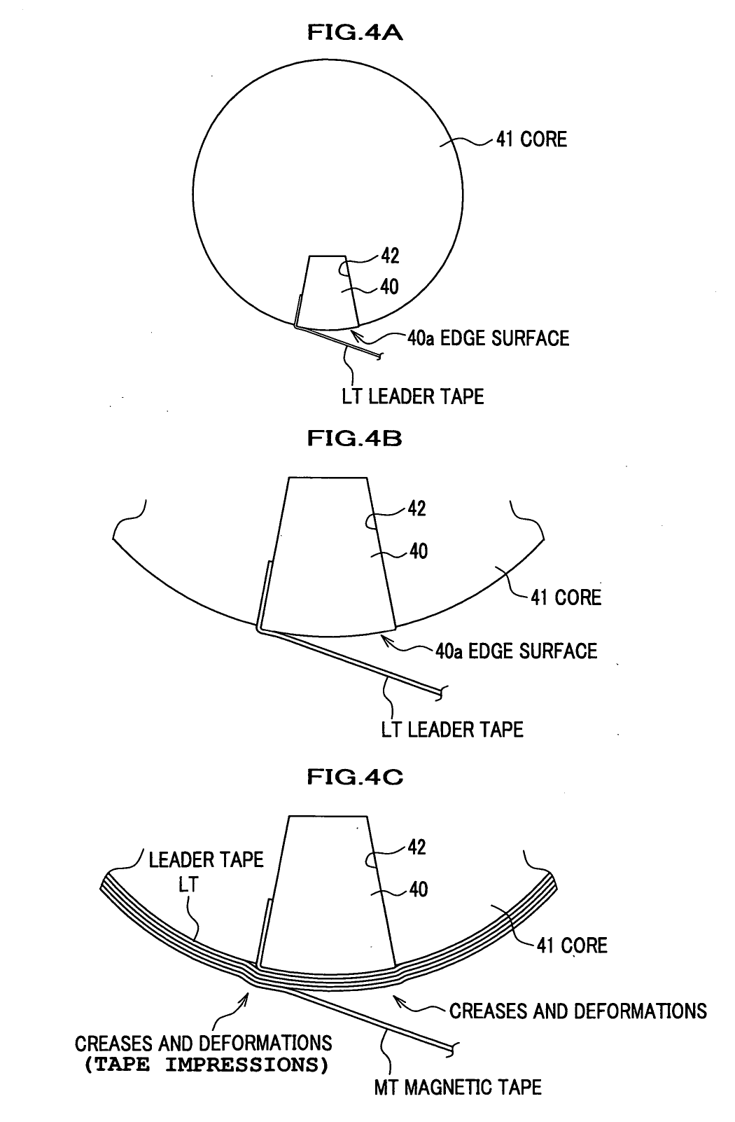

As shown in FIGS. 3A and 3B, on a flange 21a on the bottom of the drive reel 21, grooves 21b are formed radially at regular intervals. These grooves 21b are formed to occupy 10% to 50% of the whole area of the flange 21a, and preferably 30% to 50% of the whole area. These grooves 21b function as exhaust paths for directing, to the outside of the drive reel 21, an airflow generated when the drive reel 21 winds the magnetic tape MT.

A description will be given below of operations of the magnetic tape drive 20.

Once the magnetic tape cartridge 10 is loaded into the magnetic tape drive 20 as shown in FIG. 1, the pull-out guide 32 (see FIG. 2) pulls out the leader pin 30, then moves it to the drive reel 21 past the magnetic head H, and the leader block 31 is fitted into a recess 23 on the core 22 of the drive reel 21. Note that a locked portion (not shown) is provided in the recess 23. This locked portion is attached to the leader block 31, thereby preventing the leader block 31 from protruding from the recess 23.

The spindle drive 25 and the take-up drive 26 rotate the spindle 24 and the drive reel 21, respectively, in the same direction under the control of the controller 27, so that the leader tape portion LT and the magnetic tape MT are transported in the direction from the cartridge reel 11 to the drive reel 21. Afterward, the leader tape portion LT is wound around the drive reel 21, and the magnetic tape MT is then wound therearound as well, and at the same time, information is recorded/reproduced on or from the magnetic tape MT. In this embodiment, the leader tape portion LT is 0.9 m in length, and is therefore about 12 μm in total thickness when being wound up around the core 22 of the drive reel 21. In this case, the leader tape portion LT is wound about seven times therearound. In other words, the leader tape portion LT is stacked on the core 22 of the drive reel 21.

When the magnetic tape MT is rewound around the cartridge reel 11, the spindle 24 and the drive reel 21 are rotatably driven in the reverse direction, so that the magnetic tape MT is transported to the cartridge reel 11. In this case, information is recorded/reproduced on or from the magnetic tape MT by the magnetic head H as with the case where the magnetic tape MT is forwardly transported.

In the tape drive system 1, the magnetic tape MT stays wound around the cartridge reel 11 in many cases, but in some cases, it stays wound around the drive reel 21 for a long time. In such cases, especially, the tape drive system 1 according to the embodiment can be provided appropriately. Specifically, before the magnetic tape MT is wound around the drive reel 21 of the magnetic tape drive 20 from the magnetic tape cartridge 10, the leader block 31 pulls out the magnetic tape MT from the magnetic tape cartridge 10, and is then fitted into the recess 23 on the core 22 of the drive reel 21. However, due to the tolerance of dimensions of the leader block 31, the leader block 31 may protrude from the periphery of the core 22, thus forming the step heights. In this case, because of these step heights, tape impressions may be formed on the leader tape being wound around the drive reel 2. Consequently, recording errors or lack of information on the magnetic tape MT may occur.

However, in the tape drive system 1, the leader tape portion LT skillfully absorbs these step heights, thereby minimizing recording errors or lack of information on the magnetic tape MT.

Next, by using the tape drive system 1 described above, an error rate test was performed on the magnetic tape MT.

The conditions of this test were as follows.
(1) The magnetic tapes MT, that is, test samples with different center line average roughnesses Ra and different thicknesses were used.
(2) The respective total areas of the grooves 21b were varied.
(3) The length of the leader tape portions LT of the individual test samples was 0.9 m.
(4) The magnetic tape MT had been kept wound beforehand around the drive reel 21 at room temperatures for 48 hours.
(5) Step heights of 100 μm were formed on the core 22 of the drive reel 2.
(6) Comparative samples provided with leader tapes having center line average roughnesses Ra of 5 nm (smooth), 70 nm (rough) and 25 nm (typical), respectively, were used,

The test result is shown in a table 1.

TABLE 1

| | LEADER | LEADER | GROOVE | | |
|---|---|---|---|---|---|
| | TAPE | TAPE | TOTAL | | |
| | Ra | THICKNESS | AREA | ERROR | WINDING |
| | (nm) | (nm) | (%) | RATE | FORM |
| SAMPLE 1 | 25 | 30 | 35 | 1 × 10⁻⁶ | EXCELLENT |
| SAMPLE 2 | 12 | 30 | 35 | 8 × 10⁻⁶ | EXCELLENT |
| SAMPLE 3 | 55 | 30 | 35 | 7 × 10⁻⁶ | EXCELLENT |
| SAMPLE 4 | 25 | 40 | 35 | 6 × 10⁻⁶ | EXCELLENT |
| COMPARATIVE | 5 | 30 | 35 | 5 × 10⁻⁵ | EXCELLENT |
| SAMPLE 1 | | | | | |
| COMPARATIVE | 70 | 30 | 35 | 4 × 10⁻⁵ | EXCELLENT |
| SAMPLE 2 | | | | | |
| COMPARATIVE | 25 | 50 | 5 | 4 × 10⁻⁴ | POOR |
| SAMPLE 3 | | | | | |

All the error rate tests of the samples 1 to 4 showed excellent results, and it can therefore be found that the samples were not affected by the creases and the deformations being formed due to the step heights. In contrast, it can be found that all the comparative samples 1 to 3 were affected by the creases and the deformations.

Next, by using the tape drive system, an additional error rate test was conducted. The conditions were as follow.
(1) The magnetic tapes MT, that is, test samples having the leader tape portions LT of different lengths were used.
(2) The test samples were kept wound around the drive reel 21.
(3) A comparative sample having the leader tape of 1 m (typical length) was used.

The error rate test result is shown in the table 2.

TABLE 2

| | LEADER | GROOVE | | |
|---|---|---|---|---|
| | TAPE | TOTAL | | |
| | LENGTH | AREA | ERROR | WINDING |
| | Ra (nm) | (%) | RATE | FORM |
| SAMPLE 1 | 10 | 35 | 8 × 10⁻⁶ | EXCELLENT |
| SAMPLE 2 | 15 | 35 | 1 × 10⁻⁶ | EXCELLENT |
| SAMPLE 3 | 20 | 35 | 6 × 10⁻⁶ | GOOD |
| COMPARATIVE | 1 | 35 | 5 × 10⁻⁵ | EXCELLENT |
| SAMPLE 1 | | | | |

All the error rate tests of the samples 1 to 3 showed excellent results, and it can therefore be found that the samples were not affected by the tape impressions. In contrast, it can be found that the comparative sample 1 was affected by the tape impressions formed due to the step heights.

Based on the test results above, the relationship between the leader tape portion LT and the groove 21b of the drive reel 21 are determined. This relationship is shown in the table 3.

TABLE 3

| | DRIVE REEL | |
|---|---|---|
| LEADER TAPE | WITHOUT GROOVES | WITH GROOVES |
| SMOOTH AND | (WINDING FORM) | (WINDING FORM) |
| THIN | POOR | VERY GOOD |
| | (TAPE IMPRESSIONS) | (TAPE IMPRESSIONS) |
| | GOOD | POOR |
| ROUGH AND | (WINDING FORM) | (WINDING FORM) |
| THICK | POOR | VERY GOOD |
| | (TAPE IMPRESSIONS) | (TAPE IMPRESSIONS) |
| | EXCELLENT | VERY GOOD |

In this table, “excellent”, “very good”, “good” and “poor” indicate no abnormalities, a few abnormalities, several abnormalities and many abnormalities, respectively.

According to this result, it can be found that the magnetic tape MT on which any tape impressions are not formed and which can be wound in proper alignment can be applied on the condition that the leader tape portion LT is formed to be rough and thick and that the drive reel 21 has grooves 21b.

As for the grooves 21b, functioning as exhaust paths, an air flow generated by the transportation of the magnetic tape MT is directed to the outside of the drive reel 21 through the grooves 21b. In this embodiment, the grooves 21b occupy 10% to 50% of the whole area of the flange 21a, so that the airflow is directed smoothly to the outside of the drive reel 21 through the grooves 21b. Consequently, the magnetic tape MT is wound around the drive reel 21 along the flange 21a in proper alignment.

As for the roughness of surface of the leader tape portion LT, in this embodiment, one surface of the leader tape portion LT has the center line average roughness Ra of 10 nm to 60 nm, and the total thickness of leader tape portion LT is 20 μm to 40 μm while being wound around the drive reel 21. Therefore, due to the roughness, an elastic force is exerted on the leader tape portion LT being wound around the drive reel 21. As a result, this elastic force has a role in absorbing the step heights.

As for the length of the leader tape portion LT, in this embodiment, the leader tape portion LT is long enough to be wound three times around the drive reel 21, and the magnetic tape MT is thus wound around the circumference of the leader tape portion LT being stacked. Hence, even if step heights are formed on the core 22 of the drive reel 21, the stacked leader tape portion LT absorbs the step heights.

In conclusion, by providing the grooves on the flange of the drive reel in the tape drive and by optimizing the surface roughness and the length of the leader tape portion of the magnetic tape, it is possible to provide the tape drive system which can wind the magnetic tape in proper alignment and which minimizes the possibility of tape impressions on the magnetic tape even if the core of the drive reel has step heights on its peripheral surface.

Up to this point, the tape drive system according to the embodiment of the present invention has been described. However, a tape drive system of the present invention is not limited to that of this embodiment. It is further obvious that the various modifications and variations can be conceived without departing the spirit and the scope of the present invention as appropriate. To give an example, the leader tape to be wound around the supply reel may have the same shape as that to be wound around the take-up reel. Furthermore, the flange of the take-up reel may have grooves of any given shape.

1. A tape drive system including a tape-shaped recording medium, a supply reel and a take-up reel, for winding the tape-shaped recording medium wound around the supply reel to the take-up reel or for winding the tape-shaped recording medium wound around the take-up reel to the supply reel, and simultaneously for recording/reproducing information to or from the tape-shaped recording medium, the tape drive system comprising:
a leader tape formed at a head edge of the tape-shaped recording medium, wherein the leader tape intends to prevent tape impressions from being formed on the tape-shaped recording medium;
a plurality of grooves formed on an inner surface of an flange of the take-up reel or the supply reel, the grooves for directing an airflow to an outside of the flange, the airflow being generated upon winding of the tape-shaped recording medium; and
the leader tape having a surface of a center line average roughness ranging from 10 nm to 60 nm, the leader tape having a total thickness ranging from 10 μm to 40 μm while being wounded up around the supply reel or the take-up reel.

2. The tape drive system according to claim 1,
wherein the leader tape has a length to be wound at least three times around the supply reel or the take-up reel.

3. The tape drive system according to claim 1,
wherein the leader tape has a length to be wound at least seven times around the supply reel or the take-up reel.

4. The tape drive system according to claim 1,
wherein the leader tape has a length to be wound at least twenty times around the supply reel or the take-up reel.

5. The tape drive system according to claim 1,
wherein the grooves are provided on the flange of a bottom of the supply reel or the take-up reel.

6. The tape drive system according to claim 2,
wherein the grooves are provided on the flange of a bottom of the supply reel or the take-up reel.

7. The tape drive system according to claim 3,
wherein the grooves are provided on the flange of a bottom of the supply reel or the take-up reel.

8. The tape drive system according to claim 4,
wherein the grooves are provided on the flange of a bottom of the supply reel or the take-up reel.

9. The tape drive system according to claim 1,
wherein the grooves have a total area ranging from 10% to 50% of a whole area of the flange.

10. The tape drive system according to claim 2,
wherein the grooves have a total area ranging from 10% to 50% of a whole area of the flange.

11. The tape drive system according to claim 5,
wherein the grooves have a total area ranging from 10% to 50% of a whole area of the flange.

12. The tape drive system according to claim 6,
wherein the grooves have a total area ranging from 10% to 50% of a whole area of the flange.

13. The tape drive system according to claim 1,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

14. The tape drive system according to claim 2,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

15. The tape drive system according to claim 5,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

16. The tape drive system according to claim 6,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

17. The tape drive system according to claim 9,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

18. The tape drive system according to claim 10,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

19. The tape drive system according to claim 11,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.

20. The tape drive system according to claim 12,
wherein the supply reel comprises a cartridge reel provided in the magnetic tape cartridge,
wherein the take-up reel comprises a drive reel of the tape drive into which the magnetic tape cartridge is to be loaded, and
wherein the leader tape is bonded to a head edge of the tape-shaped recording medium being wound around the cartridge reel of the magnetic tape cartridge, and is wound around the drive reel of the tape drive while leading the tape-shaped recording medium.
